(19) United States
(12) Patent Application Publication
(10) Pub. No.: US 2005/0111224 A1
(43) Pub. Date: May 26, 2005

(54) Swing lamp adapted to show flickering light and shade

(76) Inventor: Ming-Kuei Lin, Taipei Hsien (TW)

Correspondence Address: TROXELL LAW OFFICE PLLC, SUITE 1404, 5205 LEESBURG PIKE, FALLS CHURCH, VA, 22041, US

(21) Appl. No.: 10/721,293

(22) Filed: Nov. 26, 2003

(51) Int. Cl. F21V 21/20

(52) U.S. Cl. 362/276; 362/401; 362/802; 362/806

(57) ABSTRACT

A swing lamp includes a housing and a light-emitting device mounted in the housing. The housing is so structured that it may swing like a tumbler when it is pushed or touched. The light-emitting device includes a flexible lamp holder, and a plurality of light-emitting diodes mounted on a top of the flexible lamp holder and powered by a power supply to emit light toward a translucent upper part of the housing in different directions. When the housing is pushed to swing, the flexible lamp holder in the housing sways at the same time, causing the light emitted from the light-emitting diodes to produce irregularly changeful light and shade at different positions on the housing and thereby enabling the swing lamp to provide a dynamic ornamental effect.

### FIELD OF THE INVENTION

The present invention relates to a swing lamp, and more particularly to a swing lamp having an internal flexible lamp holder. When a housing of the swing lamp is pushed to swing like a tumbler, the flexible lamp holder sways at the same time, so that color light emitted from light-emitting diodes mounted on a top of the flexible lamp holder are projected on the housing to produce flickering and changeful light and shade at different positions.

### BACKGROUND OF THE INVENTION

There are various differently designed lighting fixtures, including swing lamps. A conventional swing lamp normally includes a translucent housing that may be freely pushed to swing like a tumbler, and a lighting device fixedly mounted in the housing. When the lighting device emits light while the housing is swinging, the emitted light swings regularly along with the swinging housing to produce a dynamic ornamental effect.

It is noted the lighting device is fixedly mounted in the housing to move along with the swinging housing in the same direction. That is, the housing and the lighting device are not moving in a relative motion. Therefore, there is not changeful and flickering light and shade produced by the moving lighting device on the swinging housing.

### SUMMARY OF THE INVENTION

A primary object of the present invention is to provide a swing lamp that is adapted to produce flickering and changeful light and shade at different positions on a housing thereof when the lamp is swinging.

To achieve the above and other objects, the swing lamp of the present invention mainly includes a housing and a light-emitting device mounted in the housing. The housing is so structured that it may swing like a tumbler when it is pushed or touched. The light-emitting device includes a flexible lamp holder, and a plurality of light-emitting diodes mounted on a top of the flexible lamp holder and powered by a power supply to emit light toward a translucent upper part of the housing in different directions. When the housing is pushed to swing, the flexible lamp holder in the housing sways at the same time, causing the light emitted from the light-emitting diodes to produce irregularly changeful light and shade at different positions on the housing and thereby enabling the swing lamp to provide a dynamic ornamental effect.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view of a swing lamp according to a first embodiment of the present invention;

FIG. 2 is an exploded perspective view of FIG. 1;

FIG. 3 is an enlarged view of a light-emitting device included in the swing lamp of the present invention; and

FIG. 4 is a perspective view of a swing lamp according to a second embodiment of the present invention.

### DETAILED DESCRIPTION OF THE PREFERRED EMBODIMENTS

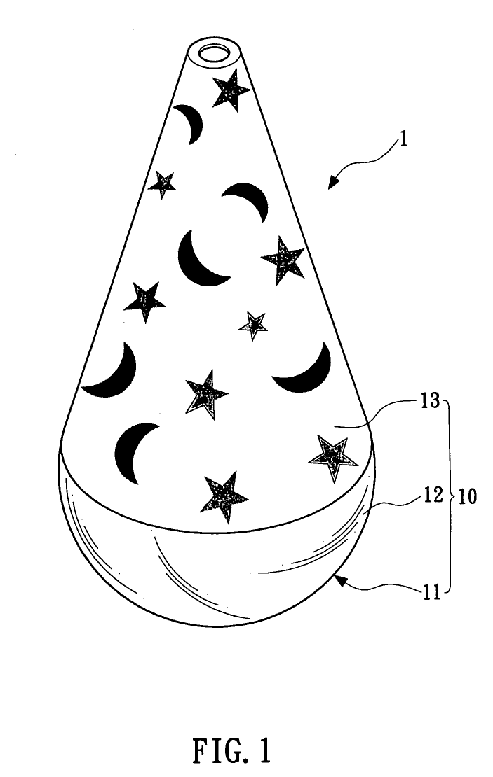

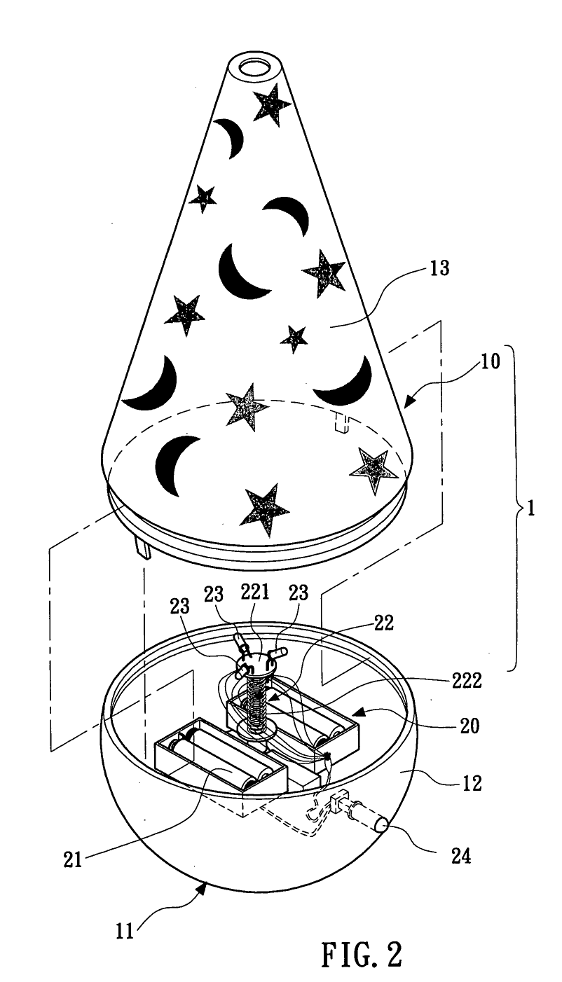

Please refer to FIGS. 1, 2, and 3 in which a swing lamp 1 according to a first embodiment of the present invention is shown. As shown, the swing lamp 1 mainly includes a housing 10 and a light-emitting device 20 mounted in the housing 10. The housing 10 may be of any shape so long as it may keep swinging like a tumbler when the lamp 1 is pushed or touched. In the first embodiment illustrated in FIGS. 1, 2, and 3, the housing 10 includes a lower housing 12 having a semispherical bottom 11, and a translucent upper housing 13. A weight, such as a metal block (not shown), is mounted in the lower housing 12, so that a center of gravity of the swing lamp 1 falls at a lower central area in the lower housing 12. With these arrangements, the housing 10 may keep swinging like a tumbler when it is pushed or touched, and return from the swinging state to an upright and balanced state after a period of time.

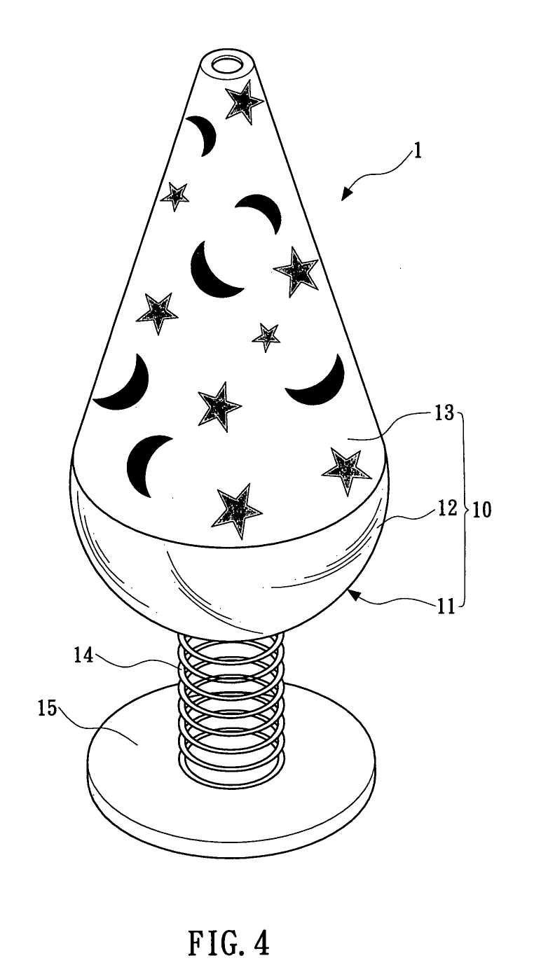

FIG. 4 shows a swing lamp 1 according to a second embodiment of the present invention. In the second embodiment, the housing 10 is connected at a bottom to a top of an elastic element 14, such as a spring providing a suitable elasticity and flexibility. The elastic element 14 is then connected at a bottom to a supporting base 15 that may stably and securely stand on a surface. When the housing 10 is pushed or touched, the elastic element 14 allows the lamp 1 to swing like a tumbler on the supporting base 15.

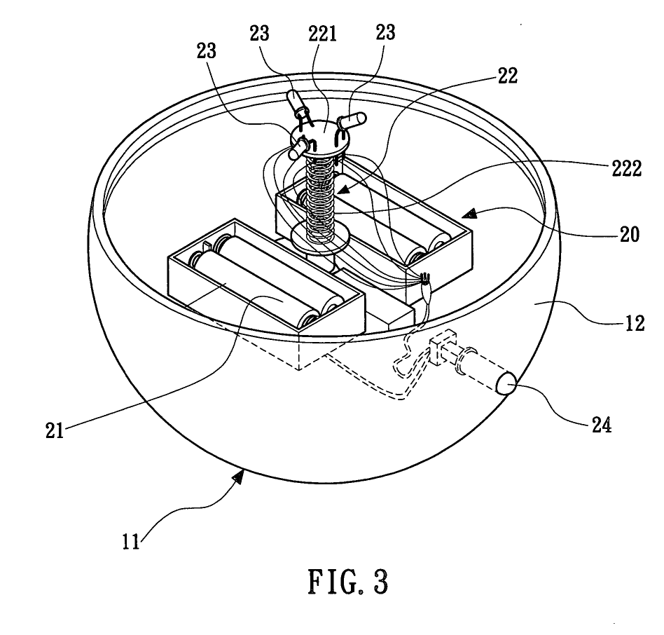

As can be clearly seen from FIG. 3, the light-emitting device 20 mounted in the lower housing 12 includes a power supply 21, a flexible lamp holder 22, a plurality of light-emitting diodes (LED) 23 mounted on a top of the flexible lamp holder 22, and an operating button 24. The power supply 21 provides power to the light-emitting diodes 23 for the same to emit light. Preferably, the flexible lamp holder 22 is fixedly connected at a lower end to an inner side of the lower housing 12 to uprightly extend from a center of the lower housing 12. The flexible lamp holder 22 includes a swing seat 221 and an elastic element 222, which may be a spring connected at an upper end to a bottom of the swing seat 221 and at a lower end to the inner bottom center of the lower housing 12. With an elastic force provided by the elastic element 222, the swing seat 221 may sway in the housing 10 to movements of the elastic element 222 without the need of any driving mechanism.

The light-emitting diodes 23 are mounted to a top of the swing seat 221 and may emit different color light in different directions to produce light and shade at different positions on the translucent upper housing 13 of the lamp 1. The operating button 24 has an end projected from a lower part of the lower housing 12 for a user to control on/off and/or illuminating patterns of the light-emitting diodes 23. For instance, it is possible for the light-emitting diodes 23 to light, extinguish, and flash alternately.

To use the swing lamp 1, simply apply a minor force to push or touch the housing 10 for the latter to move back and forth. At this point, the swing seat 221 of the flexible lamp holder 22 is also caused to sway irregularly, so that the light-emitting diodes 23 on the swing seat 221 move along with the latter to produce irregularly moving light and shade on the translucent upper housing 13. The color light emitted from the light-emitting diodes 23 further increases colorful changes in the irregular light and shade, enabling the swing lamp 1 to provide a dynamic ornamental effect.

1. A swing lamp adapted to show flickering light and shade, comprising a housing and at least one light-emitting device mounted in said housing;
said housing including a lower housing and a translucent upper housing, and having an overall shape enabling said housing to swing like a tumbler when said housing is pushed or touched; and
said light-emitting device including a flexible lamp holder, a plurality of light-emitting diodes mounted to a top of said flexible lamp holder, a power supply for supplying power to said light-emitting diodes for the latter to emit light, and an operating button;
said flexible lamp holder including a swing seat, and an elastic element fixedly connected at an upper end to a bottom of said swing seat and at a lower end to an inner side of said lower housing, such that said swing seat may sway in said housing when said elastic element is flexibly moved; and
said operating button having an end projected from a lower part of said lower housing for a user to control on/off of said light-emitting diodes and/or illuminating patterns;
whereby when said swing lamp is pushed or touched at said housing to swing to and fro in different directions, said swing seat of said light-emitting device irregularly sways in said housing at the same time, causing light emitted from said light-emitting diodes on said swing seat to produce irregularly changeful and flickering light and shade on said translucent upper housing.

2. The swing lamp adapted to show flickering light and shade as claimed in claim 1, wherein said lower housing includes a semispherical bottom, and a weight fixed to an inner bottom center of said lower housing, so that a center of gravity of said whole swing lamp falls at said inner bottom center of said lower housing to enable said swing lamp to swing like a tumbler.

3. The swing lamp adapted to show flickering light and shade as claimed in claim 1, wherein said lower housing is connected at a bottom to a top of an elastic element, and said elastic element being connected at a lower end to a supporting base, whereby said housing of said swing lamp may swing like a tumbler above said elastic element and said supporting base when said housing is pushed or touched.

4. The swing lamp adapted to show flickering light and shade as claimed in claim 1, wherein said flexible lamp holder is uprightly connected to an inner bottom center of said lower housing.

5. The swing lamp adapted to show flickering light and shade as claimed in claim 1, wherein said light-emitting diodes emit different color light.

6. The swing lamp adapted to show flickering light and shade as claimed in claim 1, wherein said light-emitting diodes emit light in different directions to produce said light and shade at different positions on said upper housing.
